(19) United States
(12) Patent Application Publication
(10) Pub. No.: US 2016/0301732 A1
(43) Pub. Date: Oct. 13, 2016

(54) Systems and Methods for Recording and Replaying of Web Transactions

(71) Applicant: Cloudy Days Inc. dba Nouvola, Portland, OR (US)

(72) Inventors: Paola Moretto, Portland, OR (US); Paola Rossaro, San Francisco, CA (US); Shawn Alan MacArthur, Portland, OR (US)

(73) Assignee: Cloudy Days Inc. dba Nouvola, Portland, OR (US)

(21) Appl. No.: 15/094,994

(22) Filed: Apr. 8, 2016

Related U.S. Application Data
(60) Provisional application No. 62/146,900, filed on Apr. 13, 2015.

(51) Int. Cl. H04L 29/08; H04L 12/26

(52) U.S. Cl. CPC H04L 67/02; H04L 43/18; H04L 43/04; H04L 43/50

(57) ABSTRACT

A method and system for generating performance tests for cloud based applications using data from real traffic. HTTP and API call transactions are recorded and converted to performance tests that can be used as is or manipulated for increased variability allowing for the creation of realistic performance tests for web based applications, allowing for the measurement and analysis of user performance metrics under real conditions.

### CROSS-REFERENCE TO RELATED APPLICATIONS

This Application claims benefit of U.S. Provisional Patent Application No. 62/146,900 filed Apr. 13, 2015, the entirety of which is incorporated herein by reference.

### BACKGROUND

In the cloud, computing resources often appear as a homogeneous pool. In reality, computing resources are a variety of different servers, computing, storage, networking and data center operations, all of which may be managed by the cloud provider. The cloud is typically device and location independent in that a user may not know the actual device or location where a component or resource physically resides. Components may access resources, such as processors or storage, without knowing the location of the resource. The provisioning of the computing resources, as well as load balancing among them, is the responsibility of the cloud service provider. This reliance on outsourced resources makes it difficult for companies deploying their applications to differentiate between issues with the cloud service provider and performance issues of their applications under high traffic/data scenarios. It also makes it challenging to stress test their applications under potential traffic/data scenarios.

While high traffic/data scenarios can be reproduced with hardware and simulations, testing using hardware requires a large amount of hardware infrastructure and is expensive. Simulations do not provide an accurate account of the behavior of real users. Additionally, while current testing methods provide some level of information on the performance at the server level, they do not provide information on end-to-end performance at the user level. There is therefore a need for better performance testing solutions for cloud-based applications.

### BRIEF SUMMARY

It should be appreciated that this Summary is provided to introduce a selection of concepts in a simplified form that are further described below in the Detailed Description. It contains, by necessity, simplifications, generalization, and omissions of detail; consequently, those skilled in the art will appreciate that the Summary is illustrative only and is not intended to be in any way limiting.

Systems and methods described herein disclose means for recording and replaying transactions for a web based application. Such recorded transactions may be archived and/or may be converted to performance tests for the web based applications. In some embodiments, the systems described herein may be considered a network cloud resource allocation system.

A method for testing cloud based applications may include recording web transactions of an Application performed by a user in a browser. Such recordings may include information such as the URL, request method, HTTP headers, HTTP header fields, HTTP message body, status line, or redirection URL. Requests and or response transactions or both may be recorded, each with its own set of headers, URL path, data and payload. In some embodiments, every API call may be recorded, including headers, URL path, data and payload. Some API transactions that may be captured include, but are not limited to, GET, POST, PUT, DELETE, HEAD as well as some or all associated data. The recorded transactions may then be archived to the cloud and performance tests created based on the recorded web transactions. The recorded transactions may be filtered removing as much or as little information as desired including, but not limited to, images, favorite icons, CSS, Javascripts and fonts. In some embodiments, such filtering may occur real-time as the recordings are made or the performance tests run. The recorded transactions may then be paired with one or more additional parameters including, but not limited to, the number of synthetic users, the time frame during which the test is to be completed, the geographic location where the test is to be centered, and the goal of the test; bringing on-line hardware and software resources in a cloud based system required to execute the test, generating a group of synthetic users required by the test, executing the test on an Application under Test, and processing and displaying performance metrics from the test. In some embodiments, recommendations for optimizing performance of the Application under Test may also be generated, allowing for the optimization of the performance and resources of the Application under Test.

In some embodiments, a cloud based performance testing system may include a recording module interface with a web browser which intercepts and records incoming and outgoing transactions such as HTTP transactions or API calls through an Application. The transactions may be archived and assigned an identifier. The transactions are then replayed using a replaying module which enables rerunning of the recorded transactions in the correct sequence, processes the recordings and coverts them to performance test scenarios by pairing the recorded transactions with one or more additional parameters including, but not limited to, a number of synthetic users, a time frame during which the test is to be completed, a data payload, randomness of the payload, a geographic location where the test is to be centered, and a goal for the test.

In a further embodiment, a cloud based performance testing system may include a group of remotely distributed subscriber computers each of which has a network interface connected to a communication network; a recording module for each of the network interfaces for the group of remotely distributed subscriber computers; a replaying mechanism; an Application under Test residing on a second computer connected to the internet; a test execution mechanism; a results mechanism that collects, processes, and stores performance measurements of the Application under Test in response to the load generated by the test execution mechanism; and a display mechanism that presents the performance measurements collected by the results mechanism and recommendations for optimizing performance of the Application under Test. The remotely distributed subscriber systems may be distributed locally or internationally as desired.

To the accomplishment of the foregoing and related ends, certain illustrative aspects of the system are described herein in connection with the following description and the attached drawings. The features, functions, and advantages that have been discussed can be achieved independently in various embodiments of the present disclosure or may be combined in yet other embodiments, further details of which can be seen with reference to the following description and drawings. The summary is provided to introduce a selection of concepts in a simplified form that are further described below in the Detailed Description. This summary is not intended to identify key features or essential features of any subject matter described herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a flowchart for recording web transactions for performance testing web applications.

FIG. 2 is a detailed diagram of a means of recording web transactions from a plurality of computing devices.

FIG. 3 is a flowchart of a method of testing, creating and applying a performance test and changing an Application under Test based on the results thereof.

FIG. 4 is a detailed diagram of an exemplary method of authenticating a user within the recording module for recording replaying web transactions.

FIG. 5 is a diagram of an exemplary recording flowchart for recording web transactions for use in performance testing web applications.

FIG. 6 is a block diagram illustrating data from an exemplary recording and an exemplary HTTP request record in accordance with an embodiment of the invention.

FIG. 7 is a block diagram illustrating an exemplary replaying module and its interface with a test execution module in accordance with an embodiment of the invention.

FIG. 8 illustrates a system 800 in accordance with an embodiment described herein.

### DETAILED DESCRIPTION

“AJAX” in this context refers to asynchronous JavaScript and XML.

“API” in this context refers to an application program interface, a set of routines, protocols, and tools for building software applications.

“API Call” in this context refers to specific operations that client applications can invoke at runtime to perform tasks.

“Archive” in this context refers to a file that is composed of one or more computer files along with metadata. Archive files are used to collect multiple data files together into a single file for easier portability and storage, or simply to compress files to use less storage space. Archive files often store directory structures, error detection and correction information, arbitrary comments, and sometimes use built-in encryption.

“Browser” in this context refers to logic that is operated by a device to access content and logic provided by Internet sites over a machine network. Browser logic provides a human-friendly interface to locate, access, utilize, and display content and logic encoded by web sites or otherwise available from servers of a network (such as the Internet).

“Cloud” in this context refers to device resources delivered as a service over a network (typically the Internet).

“Cookies” in this context refers to a technology that enables a Web server to retrieve information from a user's computer that reveals prior browsing activities of the user. The informational item stored on the user's computer (typically on the hard drive) is commonly referred to as a “cookie.” Many standard Web browsers support the use of cookies.

“Database” in this context refers to an organized collection of data (states of matter representing values, symbols, or control signals to device logic), structured typically into tables that comprise ‘rows’ and ‘columns’, although this structure is not implemented in every case. One column of a table is often designated a “key” for purposes of creating indexes to rapidly search the database.

“Filter” in this context refers to a program or section of code that is designed to examine each input or output request for certain qualifying criteria and then process or forward it accordingly.

“HTTP” in this context refers to Hypertext Transfer Protocol (HTTP). an application protocol for distributed, collaborative, hypermedia information systems.

“HTTP request” in this context refers to is a class encapsulating HTTP style requests, consisting of a request line, some headers, and a content body.

“HTTP Response” in this context refers to completion status information in response to an HTTP request about optionally requested content in its message body.

“HTTP Transaction” in this context refers to a single HTTP request and the corresponding HTTP response.

“JavaScript Object Notation (JSON)” in this context refers to a text-based open standard designed for human-readable data interchange among machines. Derived from the JavaScript scripting language, JSON is a language for representing simple data structures and associative arrays.

“Map-reduce” in this context refers to a data processing paradigm for condensing large volumes of data into useful aggregated results.

“Model” in this context refers to a programming class of functions.

“Module” in this context refers to logic having boundaries defined by function or subroutine calls, branch points, application program interfaces (APIs), or other technologies that provide for the partitioning or modularization of particular processing or control functions. Modules are typically combined via their interfaces with other modules to carry out a machine process.

“Non-relational database” in this context refers to a database that does not incorporate the table/key model that relational database management systems (RDBMS) promote. These kinds of databases require data manipulation techniques and processes designed to provide solutions to big data problems.

“Relational database” in this context refers to a database structured to recognize relations among stored items of information.

“Synthetic User” in this context refers to a virtual user that operates externally to the system and mimics real user behavior by running through user paths on a website or application.

“Uniform Resource Locator” in this context refers to refers to the global address of documents and other resources on the World Wide Web. The URL uses a protocol identifier and a resource name that identifies the IP address or the domain name where the resource is located. The URL format is specified in RFC 1739 Uniform Resource Locators (URL).

“Universally Unique Identifier (UUID)” in this context refers to a 128-bit number used to uniquely identify some object or entity on the Internet.

“Web application” in this context refers to is an application program that is stored on a remote server and delivered over the Internet through a browser interface.

“Web page” in this context refers to a file configured for access and display via a web browser over the Internet, or Internet-compatible networks. Also, logic defining an information container that is suitable for access and display using Internet standard protocols. Content defined in a web page is typically accessed using a web browser, and displayed. Web pages may provide navigation to other web pages or content via hypertext links. Web pages frequently subsume other resources such as style sheets, scripts and images into their final presentation. Web pages may be retrieved for display from a local storage device, or from a remote web server via a network connection.

### Description

User interactions with cloud based applications present a constantly shifting burden of traffic/data scenarios on an Application. Provided herein are means of capturing user interactions, allowing for the creation of performance test scenarios that mimic real life situations. In some embodiments, such test scenarios may be used to performance test cloud based applications (Application under Test). The designer of the Application under Test may use the system to create accurate and realistic performance tests to test speed and responsiveness of the Application under Test and derive a set of metrics that describe different aspects of speed and responsiveness as experienced by the users of the Application under Test. In some embodiments, the system may generate recommendations for optimizing performance of the Application under Test. The system may further implement the recommendations for the Application under Test, thereby altering its allocation of resources. The system allows for the ability to record web transactions, save and archive the transactions on cloud resources, replay the transactions with the same or different payloads, and convert the transactions into a test by pairing the recorded transactions with one or more additional parameters including, but not limited to, the number of synthetic users, the time frame during which the test is to be completed, the geographic location where the test is to be centered (locally or globally), and the goal of the test, allowing a user/developer to uncover performance issues under near real life situations.

User interactions may be intercepted at the browser level, allowing for the system to be used for any web application on any cloud provider. In some embodiments, every HTTP transaction may be recorded including headers, URL path, data and payload that is exchanged on the network while the user is navigating, browsing, or otherwise using the Application under Test. Requests and/or response transactions or both may be recorded, each with its own set of headers, URL path, data and payload. In other embodiments, every API call may be recorded, including headers, URL path, data and payload. Some API transactions that may be captured include, but are not limited to, GET, POST, PUT, DELETE, HEAD as well as some or all associated data. In other embodiments, every API call may be recorded. In additional embodiments, every API call and every HTTP transaction may be recorded.

The recorded HTTP transactions and/or API calls may be recorded, archived and/or converted into performance test scenarios. In some embodiments, the recorded transactions and/or calls may be replayed. In additional embodiments, recorded transactions and/or calls may be filtered to remove unwanted data including, but not limited to, images, icons, Javascript, fonts, CSS and the like. Filtering may also exclude calls and other analytics formats such as Google analytics or any other calls and analytics that may cause interference with capturing the desired user interactions.

The recorded web transactions may be archived on cloud database resources. In some embodiments, each transaction may be labeled with a unique identifier. In other embodiments, each user session is labeled with a unique identifier. In further embodiments, each transaction and/or user session is labeled with a unique identifier. Any type of desired identifier may be used including one more of a UUID, user ID, time and/or date stamp, or the like. Each transaction may be retrievable and viewable from the database.

The recorded transactions may be replayed from the archived database or any cache or other temporary storage location. In some embodiments, the recorded transactions and/or calls may be altered, introducing variance on payload and traffic and converted to a performance test for the Application under Test. When the recorded transactions are converted to a performance test, they may be paired with one or more specific parameters including, but not limitied to, the number of synthetic users, the time frame during which the test is to be completed, the geographic location where the test is to be centered, and the goal of the test. Additional data may be randomly generated, uploaded previously defined or real data, or newly generated data according to parameters selected by the user. In some embodiments, the conversion may determine one or more of the rate of repetition of the test, traffic distribution, timing mechanism, whole test duration, test identifier and traffic module.

Performance tests may then be executed by a test execution mechanism. The test execution mechanism may be made of one or more modules which may be independent of each other. For example, in some embodiments, the test execution module may include a configuration module, master module, client instance module and job creation module as described in further detail in U.S. patent application Ser. No. 14/830,068, filed Aug. 19, 2015, incorporated herein by reference in its entirety. In some embodiments, requests for test execution may be transmitted to a plurality of traffic generator computers. Each traffic generator computer is responsive to a timer control and applies traffic model logic to generate the required amount of traffic specified by either the replaying module or as part of the recorded transactions in the form of synthetic users in cooperation with an elastic load balancer. The master module may receive requests from the front end, send requests for configuring the module, verify the information is correct, send requests for configuring the module, verify the information is correct, send request to the job creation module and communicate the results to a display along with recommendations for optimizing the Application under Test. The results of any particular performance test may be tagged or otherwise labeled with a unique, search able identifier and either discarded or stored in the cloud based storage resources.

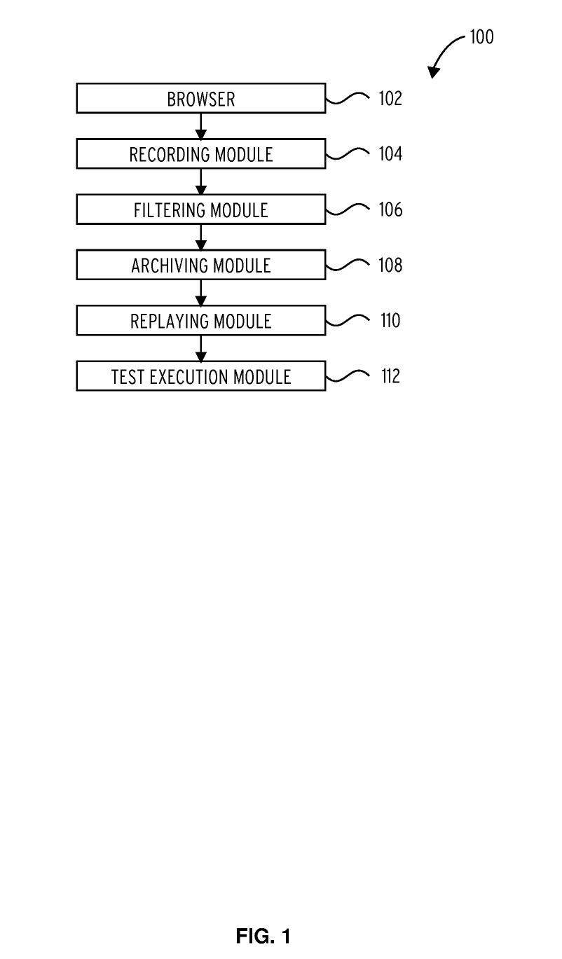

As shown in FIG. 1, information sent through browser 102 is captured by a recording module 104. The browser 102 can be any web browser used to access the internet. The recording module 102 may record HTTP transactions and/or API calls. In some embodiments, the recording module may collect data including, but not limited to one or more of: the URL, request method, HTTP headers and header fields, HTTP message body, status line and/or redirection URL. Information that may be recorded from API calls includes, but is not limited to, GET, POST, PUT, DELETE, HEAD and any or all associated data. The recorded transactions are then filtered using filtering module 106. As much or as little information as desired may be filtered from the recorded transactions. Such filtered information may include, but is not limited to, images, icons, Javascript, fonts, CSS, other analytic formats and the like. The resulting recording may then be archived in cloud based archiving module 108. In some embodiments, archived transactions may be tagged individually or in groups. The tagged transactions may be searchable, retrievable and viewable from the database. The archived transactions may be retrieved and replayed using the replaying module 110. In some embodiments, they may be converted to a performance test. The replaying module enables the rerunning of the transactions in the correct sequence. In some embodiments, the replaying module may convert the recording to a performance test, pairing the recording with one or more additional parameters including, but not limited to, the number of synthetic users, the time frame during which the test is to be completed, the geographic location where the test is to be centered, and the goal of the test. The replaying module may associate synthetic users and may also associate different data payload to the same transaction to achieve increased variance in the tests. Data may be randomly generated, an upload of previously defined data, or newly created data according to specific parameters. The performance test is then executed by the test execution module 112. Once the test is executed, the results may be displayed along with performance optimization suggestions.

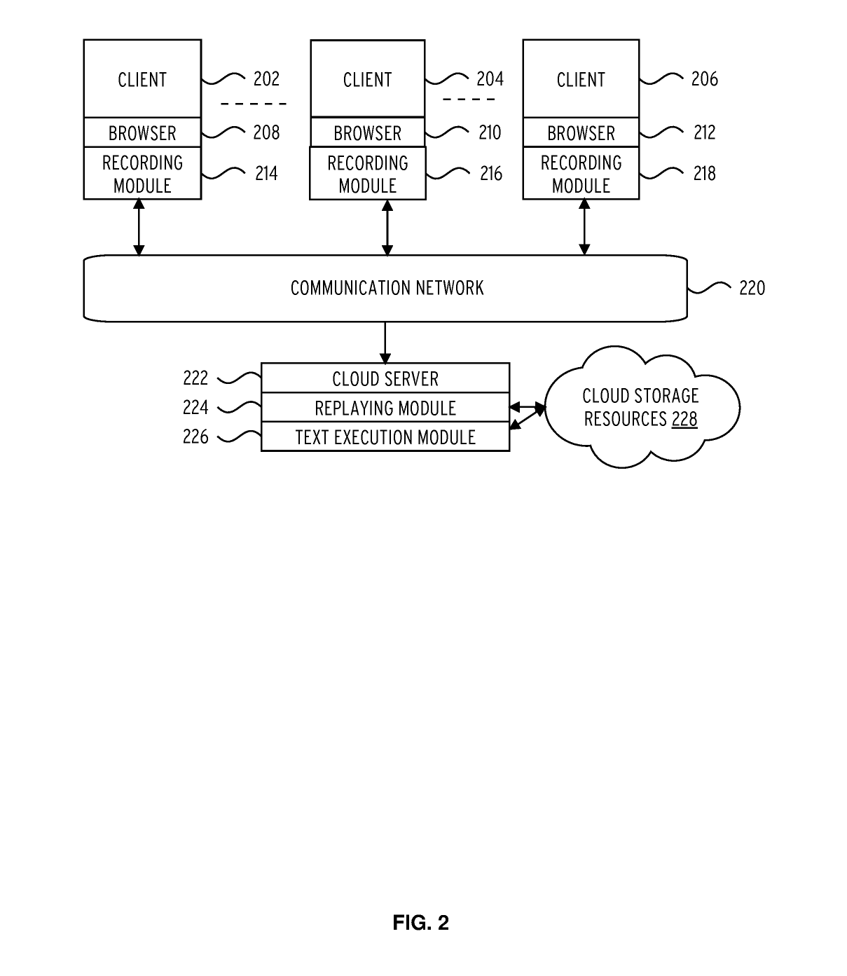

As shown in FIG. 2, transaction data can be collected from a plurality of remotely distributed client computers 202, 204, and 206, each of which has a browser 208, 210, and 212 respectively. The browsers each have recording modules 214, 216, and 218. The browsers are in communications via a communication network 220 with a server 222 that is part of the cloud (cloud server). The replaying module 224 and test execution module 226 may be located on the same or different servers. In some embodiments, the replaying module 224 and the test execution module 226 are part of the Application under Test residing on a second computer. The replaying module 224 is in communication with the recording modules 214, 216, and 218 via the communication network 220. In some embodiments, recorded transactions are stored on Cloud Storage Resources 228. In some embodiments, a results mechanism may collect, process and store performance measurements of the Application under Test in response to the load generated by the test execution mechanism and a display mechanism may present the performance measurements collected by the results mechanism as well as recommendations for optimizing performance of the Application under Test.

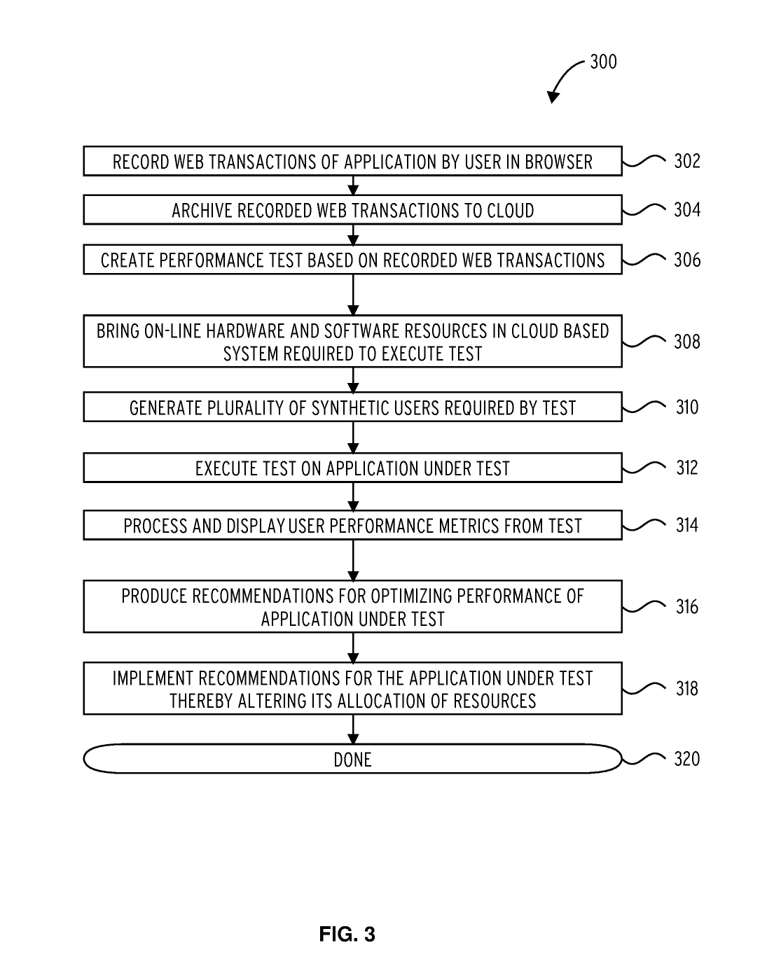

Referring to FIG. 3, web transactions by an authenticated user that take place through an Application in a browser are recorded 302. The recorded web transactions are archived to the cloud 304. A performance test is created based on the recorded web transactions 306. The required hardware and software resources in the cloud based system required to execute the test are brought online 308 along with any required synthetic users 310. The test is then executed on the Application under Test at 312. The results from the test are then processed and displayed at 314. The display may include raw data from each instance of a performance test, or may aggregate data from each instance with the same test identification, for example using a map reduce algorithm. Such map reduce algorithm may be run in any non-relational database including, but not limited to, nonSQL and Mongo. In some embodiments, the performance metrics may be displayed periodically throughout the run of the performance test. In other embodiments, performance metrics may be displayed periodically and upon completion of the test. Such performance metrics may include, but are not limited to, average transaction times vs traffic, statistical distribution of transaction times, average and worst case page load time, average and worst case time-to interact, error rates and error types distributions and the like. Such information may be presented in any format useful to the user including as text, graphs, charts, tables, cascade diagrams, scatter plots, heat maps, or any other format useful to the user. The data may be parsed to reveal behavior under a subset of conditions for example at a specific traffic level, a specific time, or when specific conditions occur as at a particular point on a transaction trime graph. In addition to test identifiers, results may include a time stamp or other identifier so that it is possible to identify the sequentece in which a test was run, i.e. before or after a specific change to an Application or before or after a specific action was taken within an Application. Recommendations for optimizing performance of the Application under Test are produced at 316 and the recommendations for the Application under Test and reallocation of its resources are performed at 318. Once the test is completed on the Application under Test and the Application under Test is optimized, the process ends 320.

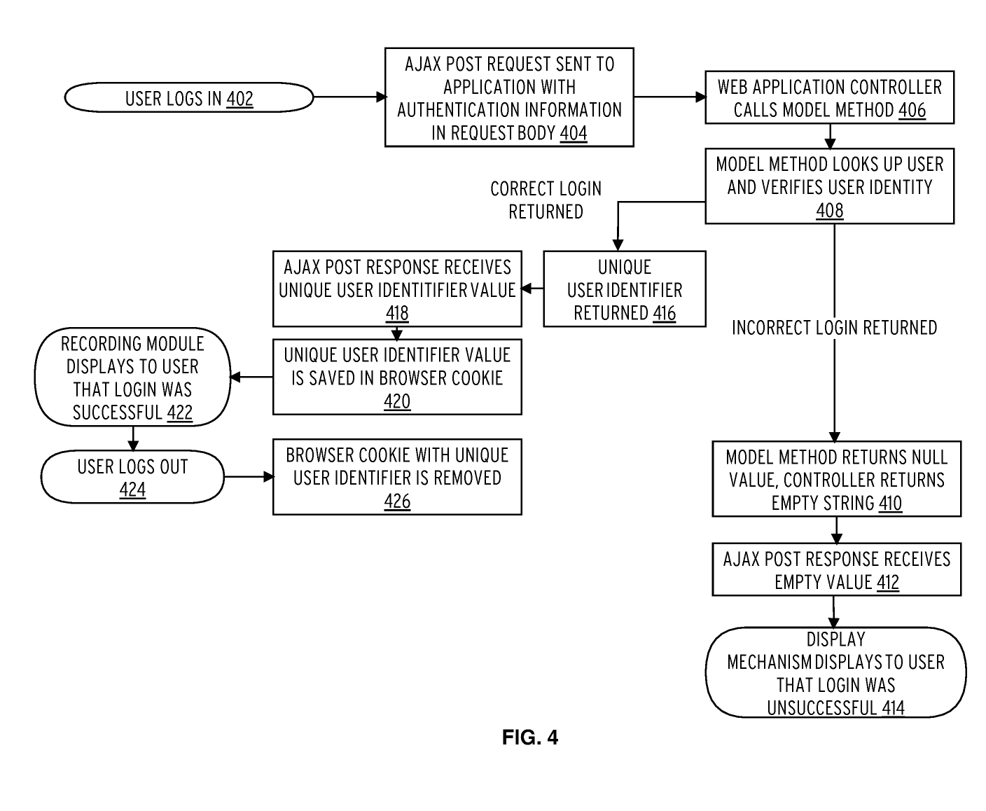

The user authentication process is shown in more detail in FIG. 4. As shown in FIG. 4, a user logs in at 402. An AJAX Post Request is then sent to the web application with authentication information in the request body at 404. The web application controller calls the model method 406. The model method verifies the user identity 408. If an incorrect login is returned, the model method returns a null value and the controller returns an empty string 410. The AJAX POST response receives an empty value at 412 and the web Application displays to the user that the login was unsuccessful at 414.

If a correct login is received, the model method and controller returns the user's UUID at 416 and the AJAX POST response receives the UUID value at 418. The UUID is saved in the browser as a cookie 420 and appended to all transactions. In some embodiments, the recording module may display that the log in was successful at 422. The user then interacts with the web Application as normal. When the user logs out at 424, the cookie with the UUID is removed.

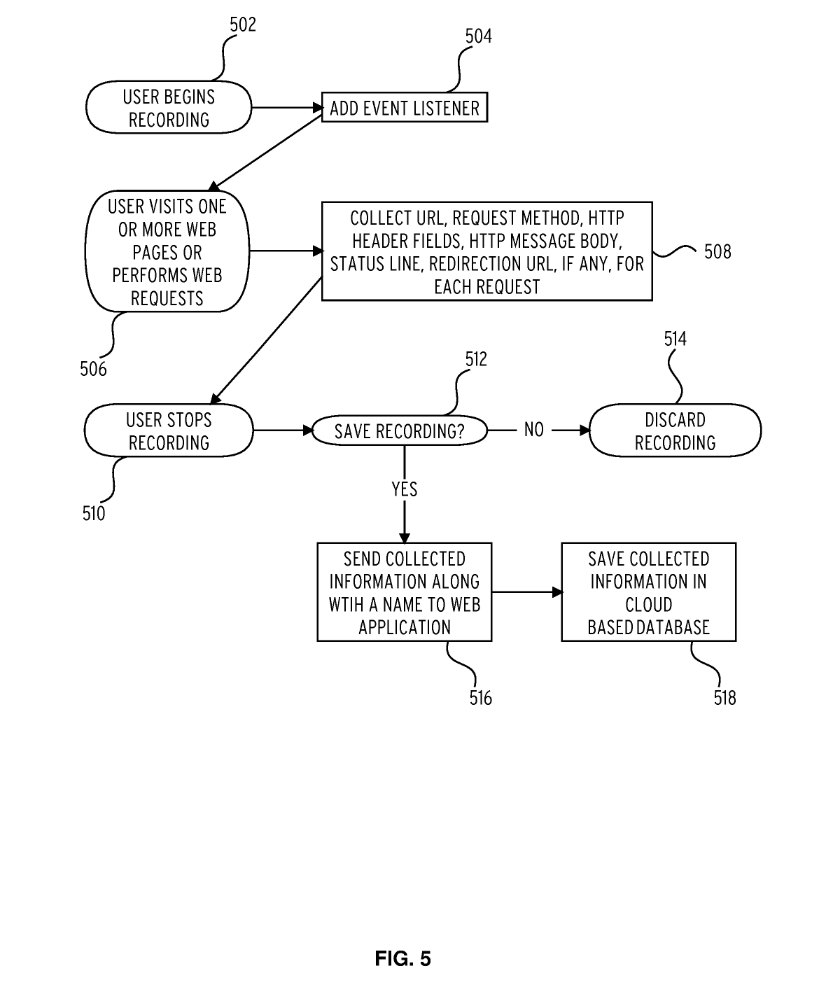

The recording process is shown in more detail in FIG. 5. As shown in FIG. 5, in some embodiments, as the user begins or starts recording at 502. An event listener 504 is introduced. The user behaves as normal, visiting one or more web pages or performing one or more web requests at 506. The event listener sends notifications about each web page being loaded and the rest of the system extracts information from each page. The system collects the desired information including, but not limited to, HTTP transactions, the URL, request method, HTTP Header, HTTP Header fields, HTTP Message Body, Status Line, Redirectional URL, API call and the like for each web page and/or web request at 508. The user may then choose to stop the recording. The user may then choose to save or delete the recording. All recorded information is then saved at 518. It may be saved in semi-structured data format in human readable form. In some embodiments, the information is saved as a JSON object. In other embodiments, it may be saved as XML. The user may elect to assign a name to the recording at 416, or a name be assigned at random. In some embodiments, the name of the recording may be associated with the user identification. All information associated with the recording may then be saved in the same or different servers in cloud storage resources at 518.

In some embodiments, the identity of the user may be authenticated before, during or after a recording is made. User authentication may be associated with a universally unique identifier (UUID) or any other desired form of identifier. In some embodiments, a user ID may be part of a cookie inserted in the browser associated with the recording module.

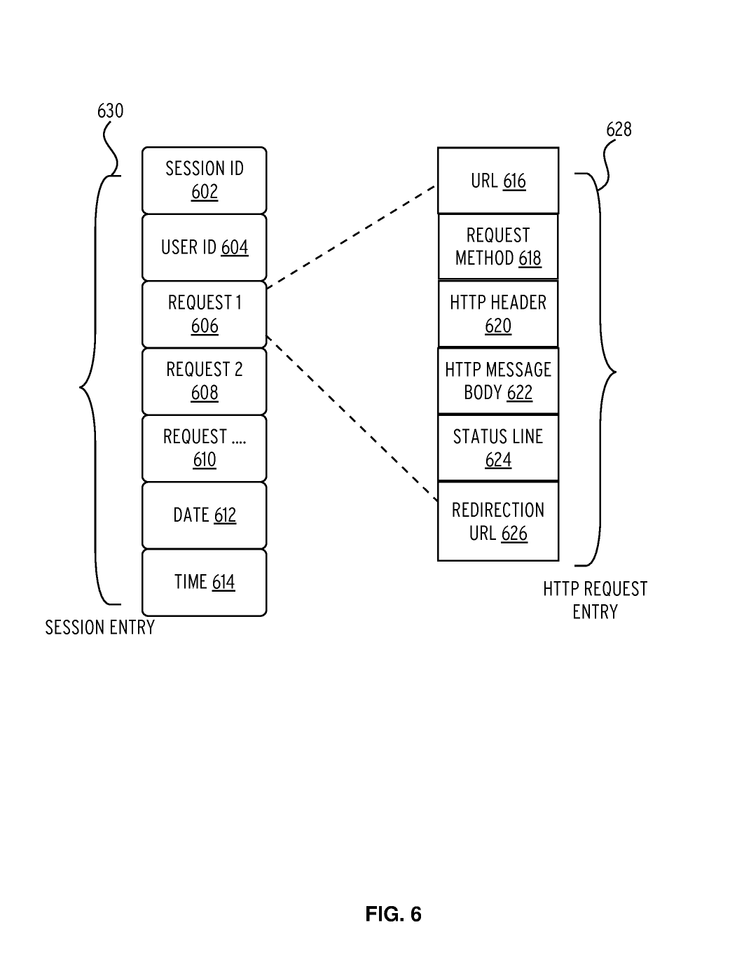

As shown in FIG. 6, during a session entry 630, a session ID 602 and a user ID 604 is attached to the recording session. The session ID 602 may include such things as a unique identifier, a date 612, time 614, or other information useful in identifying a particular recording session. The user engages in an unlimited number of transactions, Request 1 606, Request 2 608, through Request . . . 610. As shown in exemplary request HTTP Request Entry 628, a recording of a transaction may comprise one or more of the following: URL 616, request method 618, HTTP Header 620, HTTP Message Body 622, status line 624 and Redirection URL or any other desired information such as, but not limited to, HTTP Header fields and the like. For an API call, a requests entry may include GET, POST, PUT, DELETE, HEAD and any or all associated data.

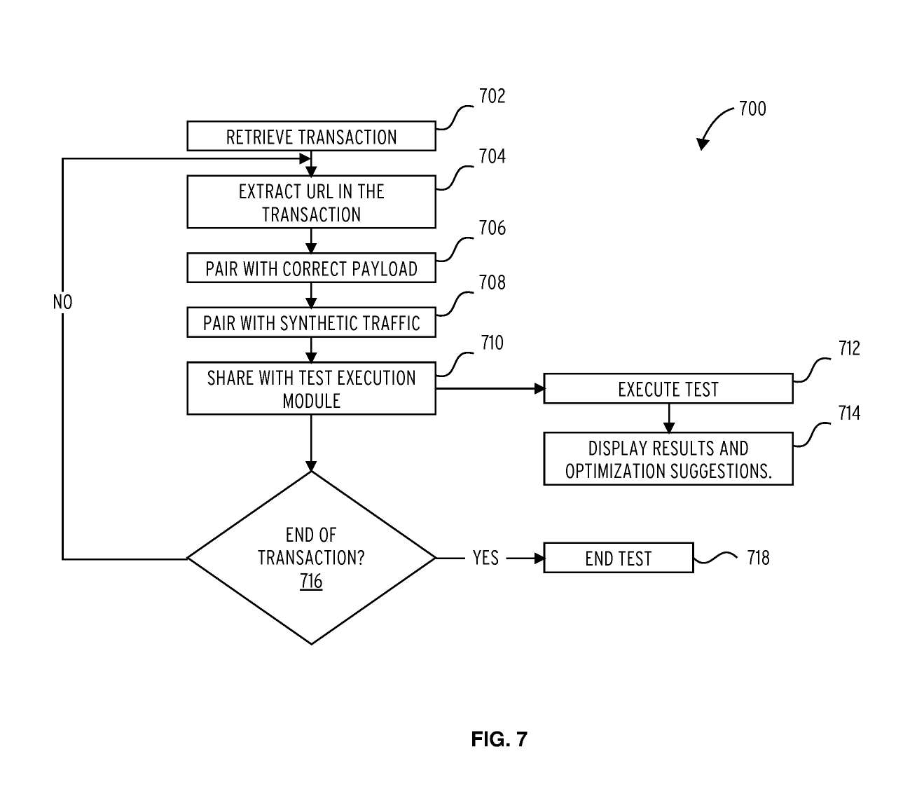

Recorded transactions may be used to create one or more performance tests. In some embodiments, the performance tests may be exact replicas of the recorded transactions. In other embodiments, the performance tests may be altered by associating it with different payloads, randomly creating data, creating data according to specific parameters, uploading previously defined data and/or previously captured real data or otherwise converted. As shown in FIG. 7, a recorded transaction is retrieved at 702 from cloud based storage. The URL is then extracted at 704 and the recording is converted to a performance test by pairing it with the right payload at 706 and synthetic traffic 708 as well as any other parameters desired by the user. The URL or other information such as recording method, request method, HTTP Header, HTTP Header field, HTTP Message Body, status line and Redirection URL and the like may be retrieved singly or in parallel allowing for increased complexity in performance tests of the Application under Test. The test is then sent to the test execution module 710, executed 712 and the results are displayed 714. The cycle of retrieving repeats until the recorded web transaction session is completed at which point the retrieval of requests ends 716 and the test ends 718.

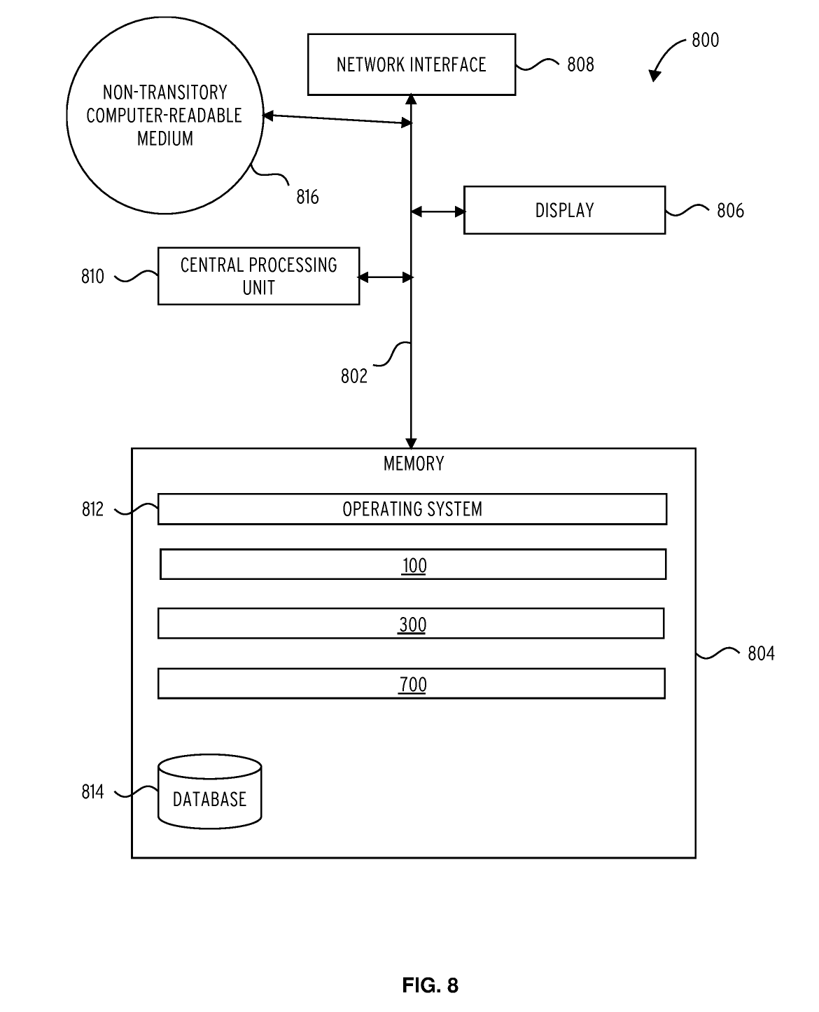

FIG. 8 illustrates several components of an exemplary system 800 in accordance with one embodiment. In various embodiments, system 800 may include a desktop PC, server, workstation, mobile phone, laptop, tablet, set-top box, appliance, or other computing device that is capable of performing operations such as those described herein. In some embodiments, system 800 may include many more components than those shown in FIG. 8. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 800 may comprise one or more physical and/or logical devices that collectively provide the functionalities described herein. In some embodiments, system 800 may comprise one or more replicated and/or distributed physical or logical devices. For example, system 800 includes a bus 802 interconnecting several components including a network interface 808, a display 806, a central processing unit 810, and a memory 804.

In some embodiments, system 800 may comprise one or more computing resources provisioned from a “cloud computing” provider, for example, Amazon Elastic Compute cloud (“Amazon EC2”), provided by Amazon.com, Inc. of Seattle, Wash.; Sun cloud Compute Utility, provided by Sun Microsystems, Inc. of Santa Clara, Calif.; Windows Azure, provided by Microsoft Corporation of Redmond, Wash., and the like.

Memory 804 generally comprises a random access memory (“RAM”) and permanent non-transitory mass storage device, such as a hard disk drive or solid-state drive. Memory 804 stores an operating system 812 as well as processes item 100, item 300 and item 700.

These and other software components may be loaded into memory 804 of system 800 using a drive mechanism (not shown) associated with a non-transitory computer-readable medium 816, such as a floppy disc, tape, DVD/CD-ROM drive, memory card, or the like.

Memory 804 also includes database 814. In some embodiments, system 800 may communicate with database 814 via network interface 808, a storage area network (“SAN”), a high-speed serial bus, and/or via the other suitable communication technology.

In some embodiments, database 814 may comprise one or more storage resources provisioned from a “cloud storage” provider, for example, Amazon Simple Storage Service (“Amazon S3”), provided by Amazon.com, Inc. of Seattle, Wash., Google cloud Storage, provided by Google, Inc. of Mountain View, Calif., and the like.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this Application, refer to this Application as a whole and not to any particular portions of this Application. When the claims use the word “or” in reference to a list of two or more items, that word covers all of the following interpretations of the word: any of the items in the list, all of the items in the list and any combination of the items in the list, unless expressly limited to one or the other. “Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

Those skilled in the art will recognize that optical aspects of implementations may involve optically-oriented hardware, software, and or firmware. The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one Application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Embodiments of an application performance testing system have been described. The following claims are directed to said embodiments, but do not preempt application performance testing in the abstract. Those having skill in the art will recognize numerous other approaches to application performance testing are possible and/or utilized commercially, precluding any possibility of preemption in the abstract. However, the claimed system improves, in one or more specific ways, the operation of a machine system for application performance testing, and thus distinguishes from other approaches to the same problem/process in how its physical arrangement of a machine system determines the system's operation and ultimate effects on the material environment. The terms used in the appended claims are defined herein in the glossary section, with the proviso that the claim terms may be used in a different manner if so defined by express recitation.

What is claimed is:

1. A cloud based performance testing system comprising:
a recording module interfaced with a web browser which intercepts incoming and outgoing transactions;
an archiving module on an application server which receives recordings of the incoming and outgoing transactions performed by a user on the web browser and assigns an identification to each recorded transaction;
a replaying module which enables rerunning of the recorded transactions in a correct sequence, processes the recordings and converts them to performance test scenarios;
a test execution module that generates load responsive to the performance test created by the replaying module responsive to a timer control based on parameters specified in the recorded transactions and directed against an Application under Test in a cloud; and
a display mechanism that presents performance measurements and recommendations for optimizing performance of the Application under Test.

2. The cloud based performance testing system of claim 1, wherein the replaying module associates synthetic users with the performance test scenarios.

3. The cloud based performance testing system of claim 1, wherein the replaying module varies data payload in a same transaction.

4. The cloud based performance testing system of claim 3, wherein the data is randomly generated.

5. The cloud based performance testing system of claim 3, wherein the data is previously defined.

6. The cloud based performance testing system of claim 1, wherein the incoming and outgoing transactions are HTTP transaction.

7. The cloud based performance testing system of claim 1, wherein the incoming and outgoing transactions are API calls.

8. A cloud based performance testing system comprising:
a plurality of remotely distributed subscriber computers each of which has a network interface connected to a communication network;
a recording module for each of the network interfaces for the plurality of remotely distributed subscriber computers;
a replaying mechanism that converts recordings from the recording module into performance tests;
an Application under Test residing on a second computer connected to the internet;
a test execution mechanism;
a results mechanism that collects, processes, and stores performance measurements of the Application under Test in response to the load generated by the test execution mechanism;
a display mechanism that presents the performance measurements collected by the results mechanism and recommendations for optimizing performance of the Application under Test.

9. The cloud based performance testing system of claim 8, wherein the plurality of remotely distributed subscriber systems are distributed throughout a world.

10. The cloud based performance testing system of claim 8, wherein the plurality of remotely distributed subscriber computers are distributed locally.

11. A method of testing cloud based applications comprising:
recording web transactions of an Application by a user in a browser;
archiving the recorded web transactions to the cloud;
creating a performance test based on the recorded web transactions;
bringing on-line hardware and software resources in a cloud based system required to execute the test;
generating a plurality of synthetic users required by the test;
executing the test on an Application under Test;
processing and displaying a performance metric from the test;
producing recommendations for optimizing performance of the Application under Test; and
implementing the recommendations for the Application under Test thereby altering its allocation of resources.

12. The method of claim 11, wherein a recording module collects at least one URL, request method, HTTP headers, HTTP header fields, HTTP message body, status line, or redirection URL.

13. The method of claim 11, wherein the web transactions are HTTP transactions.

14. The method of claim 11, wherein the web transactions are API calls.

15. The method of claim 14, wherein the API calls are GET, POST, PUT, DELETE, and HEAD.

16. The method of claim 11, wherein the recorded web transactions are filtered.

17. The method of claim 16, wherein the filtering occurs real-time.

18. The method of claim 16, wherein the filtering removes images, favorite icons, CSS, Javascripts and Fonts.
